(19) United States
(12) Patent Application Publication
(10) Pub. No.: US 2005/0124408 A1
(43) Pub. Date: Jun. 9, 2005

(54) Systems and methods for accessing, manipulating and using funds associated with pari-mutuel wagering

(76) Inventors: Kenneth A. Vlazny, York, PA (US); Brendan Burgess, Poway, CA (US); Victor I. Harrison, Glen Rock, PA (US)

Correspondence Address: TRASK BRITT, P.O. BOX 2550, SALT LAKE CITY, UT, 84110, US

(21) Appl. No.: 10/731,701

(22) Filed: Dec. 8, 2003

(51) Int. Cl. G06F 19/00; G06F 17/00

(52) U.S. Cl. 463/28

(57) ABSTRACT

Methods of pari-mutuel wagering are disclosed. One method utilizes a house card associated with an account set up by a patron at a pari-mutuel gaming establishment, such as a horse or dog racing track. The house card may be used to place wagers at a gaming terminal and, additionally, for the purchase of goods and/or services, accessing additional informational displays, or accessing secure special areas at the pari-mutuel gaming establishment. The house card acts a cash substitute wherein the patron's account may be automatically updated with all of the patron's wins, losses, and purchases via a network system or updated on the card itself using smart card technology. In another method, a credit or debit card may be utilized, instead of a house card, with an established electronic funds transfer system. In another method, the house card or credit/debit card may be used to place wagers remotely using a touchtone telephone or personal computer.

### BACKGROUND OF THE INVENTION

1. Field of the Invention

The present invention relates to systems and methods for accessing, manipulating and using funds associated with placement of a pari-mutuel wager. More specifically, the present invention relates to systems and methods of accessing funds using a house card, a credit card or a debit card in order to place a pari-mutuel wager and use of such funds for the purchase of goods, services or both on-site at the pari-mutuel betting establishment.

2. State of the Art

Pari-mutuel betting is considered one of the fairest systems of betting. The general concept of pari-mutuel wagering is a betting system in which winners share the total stakes wagered on an event, minus a percentage for the management or “house.” Stated another way, pari-mutuel wagering is a form of betting in which the losers' wagers (less a percentage for the house and taxes) are distributed among the winners.

A representative example of pari-mutuel wagering occurs in horse or dog race betting in which those who bet on the winning horses or dogs share the total stakes wagered minus a percentage set aside for the management and an amount needed to fund the purses in the race. There may be other portions of the total stakes set aside such as for taxes or other fees. In the typical horse race pari-mutuel wagering system, the finishing order of the horses (e.g., the win horse, the place horse, and the show horse) creates winning events for the bettor. However, pari-mutuel wagering need not be limited to horse or dog racing. The pari-mutuel wagering environment can be used for virtually any type of event. For example, pari-mutuel wagering may be used for sporting events such as jai alai, baseball, basketball, football, soccer, etc.

Unlike a lottery, pari-mutuel betting relies to a significant degree on the skill of the bettor. For instance in a horse or dog race, the bettor uses the racing history of the horses or dogs plus their knowledge regarding the specific type of race, length of the race, track conditions, or other conditions to determine his or her wagering decision such as, which horse will win, place, or show. Similarly, in choosing the outcome of a sporting event such as a basketball tournament, the bettor uses his or her knowledge of each of the teams, how each team will match up against another, among many other factors in determining his or her wager.

In a conventional pari-mutuel wagering environment, wagering funds are stored in either wagering accounts or on wagering vouchers. An example of the conventional pari-mutuel wagering environment can be found in U.S. Pat. No. 4,322,612 to Lange. Patrons purchase cash vouchers at teller windows or, alternatively, from terminals that accept and validate currency and issue cash vouchers. For example, a bettor typically inserts a cash voucher into a betting machine and places his or her wagers. Upon completion of the wager entry, the betting machine issues wager tickets to the bettor that reflect the wagers made and a new cash voucher that reflects the balance of credit remaining. If the bettor elects to cease wagering before all remaining credits are exhausted, the bettor may have the cash voucher converted to cash at teller terminals or may mail the voucher to the betting establishment for reimbursement. Cash vouchers afford bettors certain conveniences by reducing or eliminating the need to stand in long lines at betting windows. However, other aspects of cash vouchers are inconvenient. For example, bettors are required to keep track of multiple vouchers as wagers are placed throughout the wagering session. Furthermore, vouchers are not particularly durable since they are made from paper. Finally, cash vouchers and the wagers produced therefrom are discrete and independent from each other (i.e., bettors must track and redeem both for full reimbursement).

Like cash vouchers, wagering accounts enable bettors to establish a credit balance from which they can make wagers. Typically, a patron purchases (or opens) a wagering account at a designated staffed area within the racing facility. Accounts can be opened in a variety of denominations, but many tracks require a minimum deposit of $50 to $100. A patron may open a wagering account either anonymously or by providing his or her name for association with the account. The patron receives a receipt that contains a unique account number and a personal identification number (PIN). Subsequently, the patron may place wagers by inputting this information into specially designated wagering terminals. The cost of each wager is automatically deducted from the account balance. When the wagering is completed, the specially designated wagering terminal may issue a receipt (not a redeemable ticket) as a confirmation of the wagers placed. Wagers are electronically stored in the host computer, and prizes for winning wagers are automatically credited to the individual's wagering account. To retrieve funds from the wagering account, a patron can go to a teller at a betting establishment or an offsite betting site and transfer money to his or her bank account, or request a check through the mail. By automatically crediting patrons' winnings, account wagering is more dynamic than the cash voucher system previously described. Like the cash voucher system, account wagering can reduce or eliminate the need to stand in long lines at betting windows by further lowering the cost of wagering equipment. Furthermore, account wagering reduces the number of tickets and vouchers that a patron must track. However, wagering accounts also present inconveniences. Establishing a wagering account can be time consuming and confusing, and as with cash vouchers, wagering accounts can be used solely for the purchase of pari-mutuel wagers onsite and offsite of the betting establishment thereby limiting their use for purposes other than wagering.

The New York Racing Association (NYRA) offers a ticketless wagering account called a NYRA One Account. A bar coded account card is provided that enables placing pari-mutuel wagers using a so-called “SAM machine” located at a race track. A patron may place a bet by inserting his or her account card in a designated slot in a SAM machine located at the race track. The patron keys in his or her PIN. A screen is displayed showing the account balance. The patron touches the caption display “Acct. Wager” and reinserts the account wagering card. The patron then places his or her wager using the interface on the SAM machine. The display screen reflects the deductions as the patron makes each bet. The patron's account associated with the account card will be credited or debited immediately after the race on which the patron wagered is made official. However, to the Applicant's knowledge, the funds associated with the NYRA One Account Card may only be used for wagering purposes, as with conventional wagering accounts.

There are numerous cashless gaming systems disclosed in the prior art. For instance, U.S. Pat. No. 5,984,779 to Bridgeman et al., the disclosure of which patent is incorporated by reference herein, discloses a gaming method for table games (e.g. blackjack, pai-gow, etc.) and real time electronic gaming (slots, draw poker, keno, bingo) where payment may be accepted using a cashless system such as coupons, credit cards, or debit cards. U.S. Pat. No. 5,265,874 to Dickinson et al. discloses a cashless gaming apparatus and method, the disclosure of which patent is incorporated by reference herein.

Another cashless gaming system is disclosed by U.S. Pat. Nos. 6,347,738 and 5,902,983 to Crevelt et al., the disclosures of each of which patents are incorporated by reference herein. The patents by Crevelt et al. disclose a gaming machine which includes apparatus necessary to send requests to and receive authorizations from an electronic funds transfer (EFT) system. All such requests for credit are limited to a preset amount, so that when a player uses an EFT transfer to obtain playing credit, that credit will be limited to no more than a specified amount. In practice, the player inserts his or her credit card, ATM card (debit card), or casino issued debit card, plus some other means for verifying a player's identity if desired, requests playing credit, and receives the preset amount of credit which can be converted to plays on the gaming machine. If the player wins, the gaming machine may be used to transfer a payout to the player's account. While cashless gaming machines, such as those disclosed by Crevelt et al., increase the ease and convenience to the player, Crevelt et al. only discloses gaming environments such as a traditional slot game, a progressive slot game, a video poker games, a keno game, a blackjack game, a multiline game, or a lottery game. Furthermore, the casino-issued debit cards are only used for wagering purposes.

Therefore, there exists a need in the art for a method of pari-mutuel wagering where the bettor has simultaneous access to funds via an EFT system or a house card for pari-mutuel wagering and the purchase of products and/or services on-site at the physical betting locations. Fulfilling this need creates a cashless, country club-like environment at the race track, making it easy to keep track of all expenditures (e.g. wins, losses, and purchases) for the day and facilitating greater spending by the patron on-site and increased revenue and profit for the pari-mutuel facility.

### BRIEF SUMMARY OF THE INVENTION

The present invention includes systems and methods of pari-mutuel gaming at an establishment such as a horse or dog racing track, or other sporting event location (e.g., a jai alai game). A player may obtain playing credit from a monetary account using a credit instrument associated with the account. Such credit instruments may include a house card, a credit card, a smart card, or a debit card. The credit instrument may then be used by a player to make purchases of goods and/or services at the establishment.

The use of the credit instrument creates a country club-like environment at the establishment that allows pari-mutuel wagering while also making it easy for a player to keep track of all of his or her wins, losses, and expenditures for the day. The use of the credit instrument separates the placement of wagers and purchase of goods and services from an outlay of cash, resulting in increased wagering and spending on concessions and services on-site at the pari-mutuel gaming establishment. Furthermore, use of the credit instrument decreases cash handling costs at the pari-mutuel gaming establishments and reduces the need for at least some of the security personnel currently used to safeguard the large amounts of cash. By betting on an account, players are relieved from the burden of checking whether their tickets are winners, as is common when vouchers are used, since all winnings are automatically credited to the player's account.

In an exemplary embodiment, a gaming terminal configured for a player to place a pari-mutuel wager is provided at an establishment. A credit instrument associated with a monetary account may be presented to a card reader in communication with the gaming terminal. At least a portion of funds of the monetary account for use at the gaming terminal may be accessed either from information about monetary account balance stored on the credit instrument, as with a smart card, or from information forwarded to the gaming terminal by a remote computer (e.g., a central server, a financial server, electronic funds transfer system, etc.). The player may then place a pari-mutuel wager at the gaming terminal on an event occurring remote from the gaming terminal using the funds obtained from the monetary account. For example, such an event may be horse or dog racing, sporting events, etc. The player may then purchase goods and/or services at the establishment using the credit instrument. This purchase of goods and/or services using the credit instrument may occur before, during, or after the player's pari-mutuel wagering session.

In another exemplary embodiment, when the result of the event wagered upon by the player is known, the result may be used to update the player's account associated with the credit instrument.

In another exemplary embodiment, the results of the wager may be sent to the player using text messaging to his or her pager or cell phone, instant messaged or emailed to the player's email address. If a house card account was used, the remaining, available balance may also be included in the information sent.

In another exemplary embodiment, the house card may comprise a magnetic strip card, a radio frequency identification transmitter, a smart card, a combination house card/credit/debit card, or a card encoded with a bar code or other coded indicia.

In another exemplary embodiment, the value of, for example, a house card may be set in a predenominated amount such as $20, $30, $40, $50, etc., by the establishment.

In another exemplary embodiment, the house card may be used to access additional betting screens or special access areas such as the club house at the establishment.

In another exemplary embodiment, the house card or the credit/debit card may be used in conjunction with a device to verify the player's identity. Examples of such devices may include a key, a smart card, an electronic button for entry of a code such as a PIN at a user interface, a finger print imaging device, a retinal scan, or another type of biometrics device.

In another exemplary embodiment, the player may be required by the gaming terminal to remove the credit instrument prior to being able to place the pari-mutuel wager.

In yet another exemplary embodiment, the request for playing credit may be initiated by inserting the credit instrument into the card reader in communication with the gaming terminal.

In another exemplary embodiment, a cashless method of pari-mutuel wagering from a remote location, such as a player's own home, using funds associated with a monetary account is disclosed. A unique identifier associated with the monetary account may be input over a communication link with a remote computer. The remote computer may be located at a pari-mutuel gaming establishment or may be located offsite from the pari-mutuel gaming establishment. The unique identifier may be an account number associated with a player's house card or credit/debit card account. The player may input the unique identifier using the keypad from a touchtone telephone or a user interface at a host website if a personal computer is being used to communicate with the remote computer. Funds from the monetary account may then be accessed and the player may place a pari-mutuel wager on an event occurring at a pari-mutuel gaming establishment using at least a portion of the funds. The player may then purchase goods and/or services sold by the establishment over the communication link.

In another exemplary embodiment, the player may purchase products or services being sold by the pari-mutuel gaming establishment over the communication link using funds from the account.

In another exemplary embodiment, the monetary account may be associated with a debit/credit card or a house card such as, a magnetic strip card, a radio frequency identification transmitter, a smart card, a combination house card/credit/debit card or a card encoded with a bar code or other coded indicia.

In yet another exemplary embodiment, the identity of the player may be verified using a unique secondary identifier such as, for example, a personal identification number or a password communicated to the remote computer over the communication link.

The present invention also includes systems to implement the above mentioned methods of pari-mutuel gaming.

These features, advantages, and alternative aspects of the present invention will be apparent to those skilled in the art from a consideration of the following detailed description taken in combination with the accompanying drawings.

### BRIEF DESCRIPTION OF THE SEVERAL VIEWS OF THE DRAWINGS

In the drawings, which illustrate what is currently considered to be the best mode for carrying out the invention:

FIGS. 1A-1C are block diagrams of pari-mutuel gaming systems on which the pari-mutuel gaming methods of the present invention described in FIGS. 2A, 2B, and 3 may be implemented

FIG. 2A is a process flow diagram of an exemplary method of the present invention which utilizes a house card for pari-mutuel wagering and for purchase of goods and/or services at the pari-mutuel gaming establishment.

FIG. 2B is a process flow diagram of an exemplary method of the present invention which utilizes a house card comprising a smart card for pari-mutuel wagering and for purchase of goods and/or services at the pari-mutuel gaming establishment.

FIG. 3 is a process flow diagram of an exemplary method of the present invention which utilizes a credit or debit card for pari-mutuel wagering and for purchase of goods and/or services at the pari-mutuel gaming establishment

FIGS. 4A and 4B are block diagrams of pari-mutuel gaming systems in which the pari-mutuel gaming methods of the present invention described in FIG. 5 may be implemented.

FIG. 5 is a process flow diagram of an exemplary method of the present invention which utilizes a house card, a credit card or a debit card for remotely placing a pari-mutuel wager over a touchtone telephone or a personal computer.

FIG. 6 is an exemplary example of the ability to use a token card onsite or offsite from a pari-mutuel gaming establishment.

### DETAILED DESCRIPTION OF THE INVENTION

The present invention includes methods for cashless pari-mutuel wagering at an establishment that offers pari-mutuel wagering such as, for example and without limitation, horse or dog racing track or an off-track betting site. In accordance with the present invention, the transfer of funds from an account used to place a pari-mutuel wager may be accomplished using an electronic funds transfer (EFT) from a credit card, debit card (ATM card), stored value card, or smart card account. The present invention also includes using a computer network to transfer funds from an account utilizing a house card that may be used to place a pari-mutuel wager. The term “account” as used throughout this disclosure includes accounts such as credit card accounts, bank accounts associated with debit cards, personal checking accounts, and accounts set up with establishments that offer gaming.

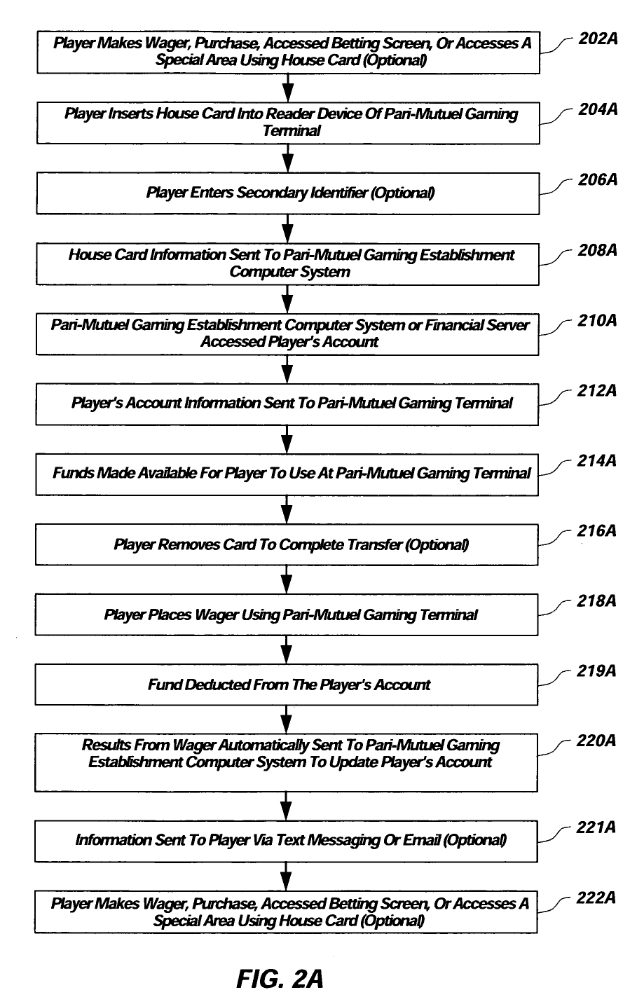

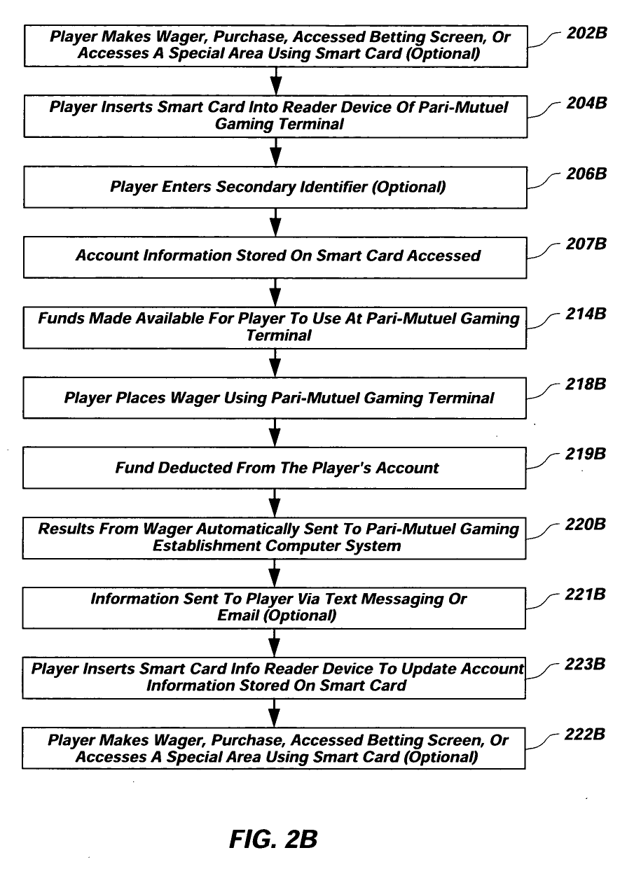

An exemplary method of the present invention, which will be hereinafter described in more detail with respect to FIGS. 2A and 2B, employs a house card that may be given to patrons at a pari-mutuel gaming establishment such as a horse or dog racing track, casino, or other establishment that allows pari-mutuel wagering. The house card is associated with an account setup by a player with the pari-mutuel gaming establishment and contains information regarding the account recorded therein. The house card may be a magnetic strip card, a radio frequency identification (RFID) transmitter, a smart card, or a card encoded with a bar code. For example, the house card may contain a 16-digit account number and a 4-digit default PIN, with both numbers printed on the back of the card. The 4-digit PIN may have a film covering it that may easily be removed by scratching to reveal it. If a magnetic strip card is used, it may be encoded with the default PIN and when used for the first time the default PIN is automatically entered. The PIN may, subsequently, be changed by the player. Thus, the house card may be initially configured as a bearer instrument (i.e., a cash substitute). Funds may be deposited into the account associated with the house card at staffed or self-serve terminals located at a pari-mutuel gaming establishment using any number of vehicles, such as, for example, cash, check, debit/credit card charges, direct deposit, among many others. If a pari-mutuel gaming establishment does not desire to invest in PIN pads at staffed terminals, self-serve terminals may issue vouchers for finds in the patron's house card account that may be redeemed at a staffed terminal or mailed to the pari-mutuel gaming establishment for redemption. Vouchers and winning tickets may be deposited into the account at a staffed or self-serve terminal that reads tickets. If the funds of his or her house card account are depleted, the player may replenish them using any one of the above methods. Also, the player's wins, losses, and expenditures may be automatically updated in the player's account with the pari-mutuel gaming establishment. If the player's winnings qualify for withholding by a tax authority, such as the Internal Revenue Service (IRS), the winnings may be flagged by the pari-mutuel gaming establishment and subsequently credited to the player's account upon completion of forms required by the tax authority.

The house card may be used for placing wagers and, additionally, for the purchase of products and/or services at the pari-mutuel gaming establishment, for accessing additional betting screens, or special access areas (e.g., the club house). Essentially, the house card operates as a cash substitute at the pari-mutuel gaming establishment. If desired, a variety of graphics may be used on the house card to assist with marketing as desired by the management of the pari-mutuel gaming establishment.

Furthermore, the house card may be a so-called “anonymous token card” in which the identity of the player is not known to the pari-mutuel gaming establishment. The house card may be issued to the player in a predenominated amount such as for $20, $30, $40, $50, etc. Pari-mutuel gaming establishments such as, horse or dog racing tracks may also market the house card in the form of a gift certificate or a gift card to attract customers. As alluded to above, the anonymous token card acts as a cash substitute and a person must have the physical card in order to redeem any cash balance. If the patron is a member of a “rewards” program at the pari-mutuel gaming establishment, the anonymous token card may be associated with a rewards card such that each wager placed using the anonymous token card will accrue points on the rewards card. The rewards points may be used for a variety of different purposes such as, credit for wagering and non-wagering purposes, access to special access areas, etc. Furthermore, the pari-mutuel gaming establishment may decide not to replace lost, stolen, destroyed, or altered anonymous token cards, along with any funds from an anonymous token card that is used without the owner's permission.

The anonymous token card may be upgraded by the patron to an “account card” by giving the pari-mutuel gaming establishment his or her name and address at a staffed or self-serve terminal or the house card may be issued initially to the patron as an account card. If the anonymous token card is upgraded, the patron may continue to use the same card as an account card or the pari-mutuel gaming establishment may issue another card. The account house card may be automatically configured to record rewards points for each wager placed using funds associated with the account card. Additionally, funds may be transferred between the patron's account card and his or her bank account by direct deposit. The account house card gives the owner an additional level of security because their identity is known. Thus, the account associated with the account house card may be promptly frozen by the pari-mutuel gaming establishment if the card is lost or stolen.

The house card may also be a so-called “super card” which comprises a combination stored value card and debit/credit card. In other words, the super card will be able to be used as both a debit/credit card and a house card with an associated account set-up with a pari-mutuel gaming establishment. In one particular aspect of the super card useful for marketing at the pari-mutuel gaming establishments, when the debit/credit card function of the super card is used for a purchase, a portion of the purchase price may be credited toward the account set up with the pari-mutuel gaming establishment. For example, if a patron uses the super card as a debit or credit card to purchases groceries, a predetermined percentage of the price of the groceries may be credited toward the house card portion of the super card. The house card portion of the super card may be set up so that it may only be able to be used at the pari-mutuel gaming establishment for specific uses such as, pari-mutuel wagering. Funds from the different portions of the super card (i.e., the debit or credit card portion and the stored value portion) may be transferred to and from each other. Furthermore, an anonymous token card or an account card may be upgraded to a super card by presenting the card to the pari-mutuel gaming establishment that will issue the patron a super card.

When the player is finished gambling, any balance on the house card may be transferred to the player's bank account, cashed-out, or the balance may remain in the house card account. The player may cash-out a balance on the house card at any staffed or self-serve terminal at the pari-mutuel gaming establishment. The player may also have a cash voucher issued by a self-serve terminal at the pari-mutuel gaming establishment that can be redeemed at a later time either by mail or at a staffed terminal. If a balance is kept on the house card, administrative fees may be deducted by the pari-mutuel gaming establishment from the remaining balance after a predetermined time period of nonuse (e.g., 12 months).

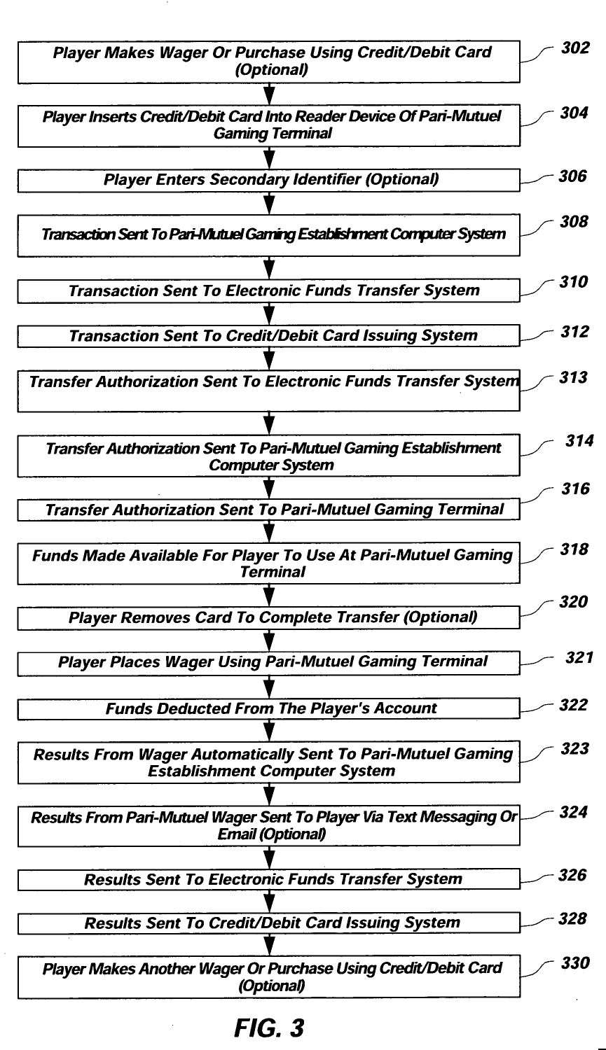

In addition to using a house card, the present invention may also utilize a conventional credit/debit card for placing pari-mutuel wagers at a pari-mutuel gaming establishment as described hereinafter in more detail with respect to FIG. 3.

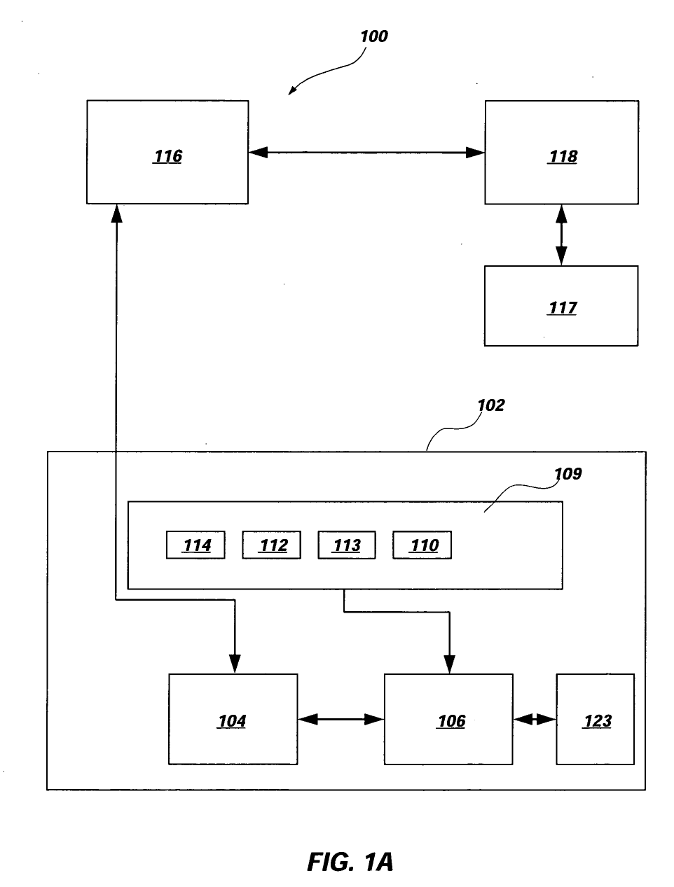

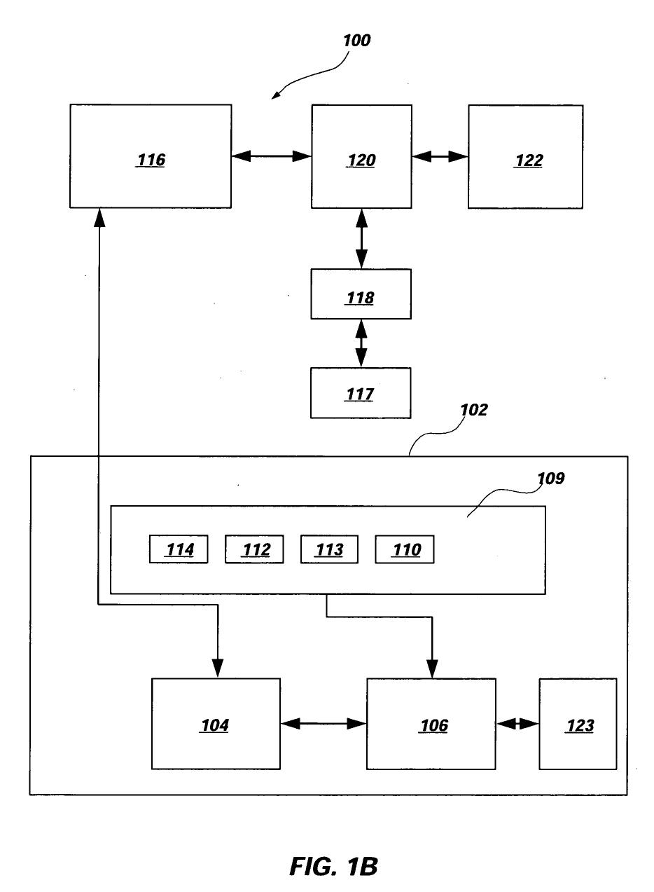

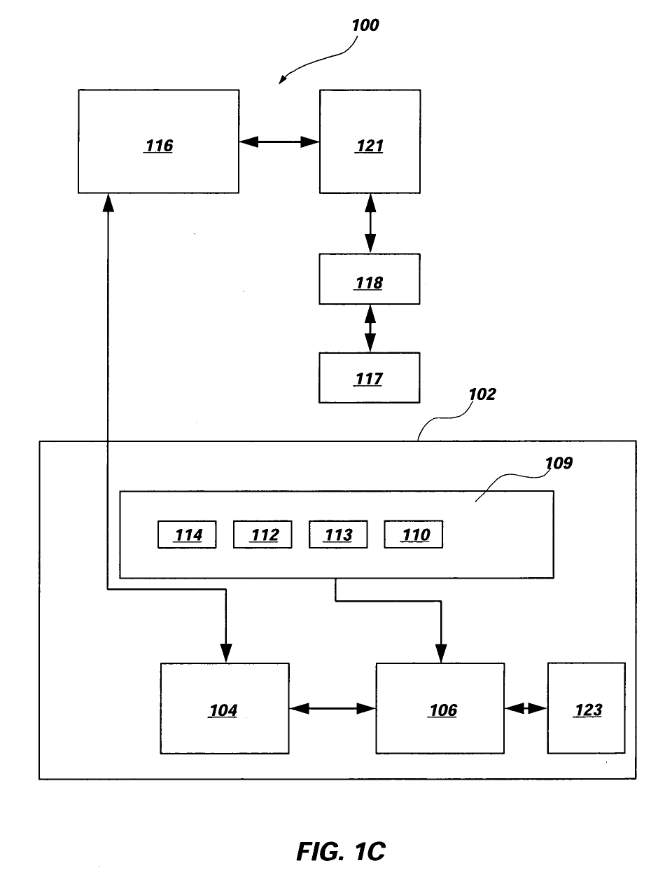

Referring to FIG. 1A, a pari-mutuel gaming system 100 is illustrated in the form of a block diagram, in which the pari-mutuel gaming methods of the present invention described in process flow diagrams FIGS. 2A, 2B and 3 may be implemented. The pari-mutuel gaming system 100 may include a pari-mutuel gaming terminal 102 that includes a player interface 109, microprocessor 106 including associated memory and software, network interface apparatus 104 with associated software, and a printer 123 if desired. The pari-mutuel gaming terminal 102 may have a housing (not shown). that supports the player interface 109 including a card reader 114 (optionally used in conjunction with secondary identifier input device 113), a player input device 110, and a display 112. A secondary identifier input device 113 may be integrated, if desired, with the card reader 114. The microprocessor 106 and its associated memory and software are in electrical communication and operably coupled with a network interface apparatus 104. The network interface apparatus 104 is operably coupled to the pari-mutuel gaming establishment computer system 116, which may include a database of player accounts, via a phone line, cable line, or other suitable, secure connection. The pari-mutuel gaming establishment computer system 116, located at the pari-mutuel gaming establishment, may be a computer system such as the Tote System sold by United Tote. Such a computer system may be configured to calculate odds, pool bets from multiple pari-mutuel gaming terminals 102, and store the player's account information and balance.

The player interface 109 is in electrical communication and operably coupled to a microprocessor 106 and provides the mechanisms necessary for a player to initiate finds transfer to and from the player's account on the pari-mutuel gaming establishment computer system 116. The card reader 114 of the player interface 109 is configured for reading encoded information on a house card, a credit card, or a debit card. The house card may comprise a magnetic strip card, a radio frequency identification (RFID) transmitter, a smart card, or a card containing a barcode or other coded indicia. The house card may be optionally used with a unique secondary identifier input device 113 such as, for example, a smart card with embedded microchips, an array of buttons for entry of a personal identification number (PIN) or other code, a key, a finger print imaging device, a retinal scan, or other biometrics device for added security measures to help verify a player's identify and account. By utilizing card reader 114, the pari-mutuel gaming establishment may dispense with the use of paper ticket readers. Compared to conventional paper ticket readers currently used at most pari-mutuel gaming establishments, a card reader 114 is less expensive and more reliable. Conventional paper ticket readers often have problems reading damaged paper tickets creating patron frustration, long lines at the pari-mutuel gaming establishment, and inaccurate ticket rejections. Furthermore, the house card, made from a material such as plastic, is much more durable than conventional paper tickets which are easily damaged by moisture and handling.

The display 112 may comprise a display such as a liquid crystal display (LCD), an LCD touch screen, a plasma display, a field emission display (FED), or employ any other suitable display technology known to those of ordinary skill in the art. The display 112, under control of a microprocessor 106, displays information pertinent to the transfer of funds from the player's account with the pari-mutuel gaming establishment. Such information may include, for example, a prompt to enter a personal identification number, a notice that the transfer of funds was authorized, an amount of the authorized transfer, and the player's account balance.

The player input device 110 may comprise, for example, a keypad, control buttons, touch display, a joy stick, a touch screen, or a combination thereof. The player input device 110 allows the player to place their pari-mutuel wager on an event, such as a dog or horse race, by enabling the player to select the outcome of the particular event being wagered on.

The pari-mutuel gaming terminal 102 may be configured with network interface apparatus 104 including components such as ports, cable connections, and/or network cards for linking the pari-mutuel gaming terminal 102 to the pari-mutuel establishment computer system 116 via an intranet and/or other network (e.g., a local area network (LAN), a wide area network (WAN), the Internet (also referred to as the World Wide Web), etc.). Encrypted communications may be employed for additional security if necessary or desirable. Although only a single pari-mutuel gaming terminal 102 is shown in FIG. 1, a plurality of pari-mutuel gaming devices 102 may be connected to the pari-mutuel gaming establishment computer system 116 (e.g., a central server) using such a network. As shown in FIG. 1B, a pari-mutuel establishment computer system 116 may also be operably coupled to an electronic funds transfer (EFT) system 120 through a connection such as, for example, by a phone or cable line, in order to utilize payment with a credit/debit card. The EFT system 120 is, in turn, operably coupled to credit/debit card issuing system 122 using a cable or phone line. As shown in FIG. 1C, in another system for implementing the methods of the present invention utilizing either a house card or a debit/credit card, the pari-mutuel gaming establishment computer system 116 will not have the player's account information and balance stored on it. Instead, the pari-mutuel gaming establishment computer system 116 may be operably coupled to a financial server 121 located offsite from the pari-mutuel gaming establishment that has the player's account balance and associated account information stored on it. It is also understood that the present invention embraces employing a commercially available customer relationship management (CRM) system, such as People Sof™, to manage and store the player's account information and account balance. The CRM system may be used in conjunction with pari-mutuel gaming establishment computer system 116 or in conjunction with an offsite computer server in communication with the pari-mutuel gaming establishment computer system 116 and computer server 118.

A card reader 117, optionally having a secondary identifier input device 113 associate therewith (not shown), may be located at concessionaires, admission entrances, special access areas, and may be in communication with either the pari-mutuel gaming establishment computer system 116, the EFT system 120, or the financial server 121 via a computer server 118 as respectively illustrated in FIGS. 1A-1C.

FIG. 2A comprises a process flow diagram wherein an exemplary method of the present invention is illustrated, which method uses a house card as a cash substitute for pari-mutuel wagering and purchases of goods and/or services at a pari-mutuel gaming establishment. The method will be described in conjunction with FIGS. 1A and 1C. Prior to act 202A, a player may have already used his or her house card for placing a wager, for the purchase of products and/or services, for accessing additional betting screens, and/or for gaining entry into a secure area such as the club house at the pari-mutuel gaming establishment. Examples of products or services available for purchase at the pari-mutuel gaming establishment may include food, drink, parking, admission, among many others. Next, in act 204A a pari-mutuel gaming terminal 102, located at a staffed or self-serve terminal at the pari-mutuel gaming establishment, detects that a player has inserted a house card into reader device 114 of a pari-mutuel gaming terminal 102. If the pari-mutuel gaming terminal 102 does not have a card reader device 114, the player's account information may be manually entered into the player interface 109 using a keypad or other suitable player interface device. Optionally, for security purposes, act 206A may be required where the player enters into the player interface 109 through a secondary identifier input device 113 a secondary identifier such as a personal identification number (PIN) entered on a key pad, or uses a smart card with an embedded microchip, an electronic button for entry of a code such as a PIN at the player interface 109, a finger print imaging device, a retinal scan, or another type of biometrics device for added security measures to help verify a player's identity for the account to be accessed. The player may also be allowed to change their PIN using the player interface 109. If the player changes his or her PIN, the pari-mutuel gaming terminal 102 may be programmed to require the player to enter the new PIN each time the house card is used. The software of the gaming terminal 102 or the card reader device 114 may be programmed to lock-out an account (i.e., prevent access to the account) if the player enters the incorrect PIN a predetermined number of times.

Again referring to FIG. 2A, after act 204A or 206A, the player's account information contained on the house card, such as a unique identification number, is sent to the pari-mutuel gaming establishment computer system 116 in act 208A. In act 210A, the pari-mutuel gaming establishment computer system 116 or the financial server 121 accesses the player's account information associated with the house card. Act 210A may take place without the player inputting the desired amount of playing credit. Instead, the pari-mutuel gaming terminal interface software may automatically generate a request for the amount of credit on the player's account. If the system of FIG. 1C is utilized, the player's account information and balance is not stored on the pari-mutuel gaming establishment computer system 116 and the pari-mutuel gaming establishment computer system 116 forwards a request to the financial server 121 to access the player's account information and balance. In act 212A the player's account information associated with the house card is automatically sent to the pari-mutuel gaming terminal 102 from the pari-mutuel gaming establishment's computer system 116 directly if the system of FIG. 1A is utilized or indirectly via the financial server 121 if the system of FIG. 1C is utilized. If the player's account balance contains a positive balance, funds are made available for the player to use at the pari-mutuel gaming terminal 102 in act 214A.

Optionally, in order to prevent the player from leaving their house card in pari-mutuel gaming terminal 102, the pari-mutuel gaming terminal 102 software may be programmed so that the player is required to remove his or her house card at act 216A before placing the wager. In act 218A, the player places a pari-mutuel wager on an event using a player input device 110 linked to the player interface 109 of the pari-mutuel gaming terminal 102. Following the placement of the pari-mutuel wager, in act 219A the finds may be automatically deducted from the player's account. Optionally, if the pari-mutuel gaming terminal 102 is equipped with a printer 123, the player may receive a printed receipt recording the wager placed.

After conclusion of the wagering event, such as a dog or horse race, the results from the race or event are automatically sent to the pari-mutuel gaming establishment computer system 116 and, if necessary, forwarded to the financial server 121 via pari-mutuel gaming establishment computer system 116, which updates the player's account information in act 220A. In other words, after the event that the player wagered upon is over, the player's account balance is updated such that winnings are added to the account balance. Following the results of the pari-mutuel wager, in act 221A, which may occur after or simultaneously with act 220A, the results of the pari-mutuel wager, the player's account balance, or both may be sent to the player via text messaging to the player's pager, cellular phone, or emailed to the player's email address. Also, after placing his or her wager, in act 222A, the player may optionally continue to place wagers on different additional events, make purchases of products and/or services, or use the house card for additional purposes (e.g., club house access, etc.) at the pari-mutuel gaming establishment using their house card at a card reader 117. Any balance remaining in the account associated with the house card may also be cashed out at a staffed termninal, a voucher may be issued at a self-serve terminal at the pari-mutuel gaming establishment that is equipped with a card reader 117, or the house card or voucher may be mailed to the pari-mutuel gaming establishment for redemption. The remaining balance may, also, be transferred by direct deposit to the player's bank account. The purchase of goods and/or services and the use of the house card for additional purposes at the pari-mutuel gaming establishment may be effected by the concessionaires of the goods and services using card readers 117 that enable purchases with a house card. Again, after each subsequent wager or purchases of goods and/or services, the player's account information may be automatically updated on the pari-mutuel gaming establishment system 116. If the funds of the account associated with the house card are depleted or if the player desires additional fuinds, the player may add funds to the account using cash, check, or credit/debit card at any staffed or self-serve terminal that accepts such payrnents. Staffed or self-serve terminals may be located at the pari-mutuel gaming establishment that have a card reader 117 that enables adding funds to the house card account with a player's credit/debit card, checks, cash, etc.

Referring to FIG. 2B, a process flow diagram for an exemplary method of the present invention is illustrated, which method utilizes a house card comprising a smart card as a cash substitute for pari-mutuel wagering and purchases of goods and/or services at a pari-mutuel gaming establishment. The smart card contains a memory chip or similar device that stores the player's account information and balance. The method will be described in conjunction with FIG. 1A. Prior to act 202B, a player may have already used his or her smart card for placing a wager, for the purchase of products and/or services, for accessing additional betting screens, and/or for gaining entry into a secure area such as the club house at the pari-mutuel gaming establishment. Examples of products or services available for purchase at the pari-mutuel gaming establishment may include food, drink, parking, admission, among many others. Next, in act 204B a pari-mutuel gaming terminal 102, located at a staffed or self-serve terminal at the pari-mutuel gaming establishment, detects that a player has inserted a smart card into the reader device 114 of a pari-mutuel gaming terminal 102. Optionally, for security purposes, act 206B may be required where the player enters into the player interface 109 through a secondary identifier input device 113 a secondary identifier such as a personal identification number (PIN) or uses a smart card with an embedded microchip, an electronic button for entry of a code such as a PIN at the player interface 109, a finger print imaging device, a retinal scan, or another type of biometrics device for added security measures to help verify a player's identity for the account to be accessed. The player may also be allowed to change their PIN using the player interface 109. If the player changes his or her PIN, the pari-mutuel gaming terminal 102 may be programmed to require the player to enter the new PIN each time the house card is used. The software of the gaming terminal 102 or the card reader device 114 may be programmed to lock-out an account (i.e., prevent access to the account) if the player enters the incorrect PIN a predetermined number of times.

Again referring to FIG. 2B, after act 204B or 206B, the player's account information contained on the smart card is accessed by the pari-mutuel gaming terminal 102 in act 207B. If the player's account balance contains a positive balance, funds are made available for the player to use at the pari-mutuel gaming terminal 102 in act 214B. In act 218B, the player places a pari-mutuel wager on an event using a player input device 110 linked to the player interface 109 of the pari-mutuel gaming terminal 102. Following the placement of the pari-mutuel wager, in act 219B the funds may be automatically deducted from the player's account updating the account balance stored on the smart card. Optionally, if the pari-mutuel gaming terminal 102 is equipped with a printer 123, the player may receive a printed receipt recording the wager placed.

After conclusion of the wagering event, such as the dog or horse race, the results from the race or event are automatically sent to the pari-mutuel gaming establishment computer system 116. Following the results of the pari-mutuel wager, in act 221B, which may occur after or simultaneously with act 220B, the results of the pari-mutuel wager may be sent to the player via text messaging to the player's pager, cellular phone, or emailed to the player's email address. In act 223B, the player may update his or her account information on their smart card, anytime after the results of the race or event are official, by inserting the smart card into a card reader 117 at the pari-mutuel gaming establishment which communicates with the pari-mutuel gaming establishment computer system 116. The pari-mutuel gaming establishment computer system 116 communicates the results of the race or event to the smart card to update the player's account information stored on the smart card. In other words, after the event that the player wagered upon is over, the player's account balance is updated such that winnings are added to the account balance stored on the smart card. Also, after placing his or her wager, in act 222B, the player may optionally continue to place wagers on different additional events, make purchases of products and/or services, or use the smart card for additional purposes (e.g., club house access, etc.) at the pari-mutuel gaming establishment using their house card at a card reader 117. Any balance remaining in the account associated with the smart card may also be cashed out at a staffed terminal, a voucher may be issued at a self-serve terminal at the pari-mutuel gaming establishment that is equipped with a card reader 117, or the smart card or voucher may be mailed to the pari-mutuel gaming establishment for redemption. The remaining balance may, also, be transferred by direct deposit to the player's bank account. The purchase of goods and/or services and the use of the smart card for additional purposes at the pari-mutuel gaming establishment may be effected by the concessionaires of the goods and services using card readers 117 that enable purchases with a smart card. Again, after each subsequent wager or purchases of goods and/or services, the player's account balance may be automatically updated and stored on the smart card. If the funds of the account associated with the smart card are depleted or if the player desires additional funds, the player may add funds to the account using cash, check, or credit/debit card at any staffed or self-serve terminal that accepts such payments. Staffed or self-serve terminals may be located at the pari-mutuel gaming establishment that have a card reader 117 that enables adding funds to the smart card account with a player's credit/debit card, checks, cash, etc.

Referring to FIG. 3, a process flow diagram for an exemplary method of the present invention that utilizes an EFT system is illustrated. The method will be described in conjunction with FIG. 1B. Prior to act 302, a player may have already used their credit/debit card for the purchase of products and/or services at the pari-mutuel gaming establishment or have already placed a wager using funds transferred via an EFT system. Next, in act 304, the pari-mutuel gaming terminal 102, located at a staffed or self-serve terminal at the pari-mutuel gaming establishment, detects that a player has inserted a credit/debit card into reader device 114 of a pari-mutuel gaming terminal 102. If the pari-mutuel gaming terminal 102 does not have a card reader device 114, the player's account information may be manually entered into the player interface 109 using a keypad or other suitable player interface device. As with the previous method described in FIGS. 2A and 2B, optionally, for security purposes, act 306 may be required where the player enters into a secondary identifier input device 113 of the player interface 109 a secondary identifier such as a personal identification number or uses a smart card with an embedded microchip, an electronic button for entry of a code such as a PIN at the player interface 109, a finger print imaging device, a retinal scan, or another type of biometrics device for added security to help verify a player's identity and account to be accessed. The software of the gaming terminal 102 or the card reader device 114 may be programmed to lock-out an account (i.e., prevent access to the account) if the player enters the incorrect PIN a predetermined number of times.

Again referring to FIG. 3, after act 304 or 306, a transaction request for a specific amount of wagering funds is sent to the pari-mutuel gaming establishment computer system 116 after the player inputs the desired amount into the player input device 112 of the player interface 109 in act 308. In act 310, the same transaction information is forwarded by the pari-mutuel gaming establishment computer system 116 to the EFT system 120 using a phone line, cable line, or other suitable communication mechanism. In act 312, the same transaction information is sent to the credit/debit card issuing system 122 by the EFT system 120. At this point in the process, the EFT system 120 treats the transaction request like any other transaction it might receive from a point of sale terminal or an ATM terminal.

In act 313, if the transaction is authorized by the credit/debit card issuing system 122, a transfer authorization is sent to the EFT system 120. In act 314, the transfer authorization for funds is forwarded by the EFT system 120 to the pari-mutuel gaming establishment computer system 116. In act 316, the transfer authorization is forwarded to the pari-mutuel gaming terminal 102 from the pari-mutuel gaming establishment computer system 116. Following the player's account information and authorization being sent to the pari-mutuel gaming establishment computer system 116, the player's desired amount of funds are made available for the player to use at pari-mutuel gaming terminal 102 in act 318.

Optionally, in order to prevent the player from leaving their credit/debit card in the pari-mutuel gaming terminal 102, the pari-mutuel gaming terminal 102 software may be programmed so that the player must remove his or her credit card at act 320 in order to place his or her wager. The player then removes his or her card at act 320 and may begin playing the pari-mutuel gaming terminal 102. In act 321, the player places a pari-mutuel wager on an event using the pari-mutuel gaming terminal 102. Following, the player placing the pari-mutuel wager, in act 322 the funds may be automatically deducted from the player's account.

After conclusion of the event, such as a dog or horse race, that was wagered upon by the player using his or her credit/debit card, in act 323, the results from the wager may be automatically sent to pari-mutuel gaming establishment computer system 116. Following the results of the pari-mutuel wager, in act 324, which may occur after or simultaneously with act 323, the results of the wager may be sent to the player via text messaging to a player's pager, cellular phone, or emailed to the player's email address. In act 326, if the player wins as a result of his or her wager, the pari-mutuel gaming establishment computer system 116 forwards a request to EFT system 120 to credit the player's credit/debit card. Then, in act 328, the EFT system 120 sends the request to credit the player's credit/debit card account to the card issuing system 122, which updates the players account information.

As with the previous embodiment described with respect to FIGS. 2A and 2B, after placing a wager, the player may optionally continue to place wagers on different events or make purchases of products and/or services at the pari-mutuel gaming establishment using the credit/debit card at a card reader 117, if so desired. The purchase of goods and/or services at the pari-mutuel gaming establishment may be effected by the concessionaires of the goods and services using card readers that enable purchases with a credit/debit card or smart card. The player may also withdraw cash from an ATM on-site at the pari-mutuel betting establishment using the credit/debit card or smart card. Again, after each subsequent wager placed by the player, the player's account information is automatically updated on the pari-mutuel gaming establishment computer system 116 and credit transferred to the player's credit/debit card account via the EFT system 120.

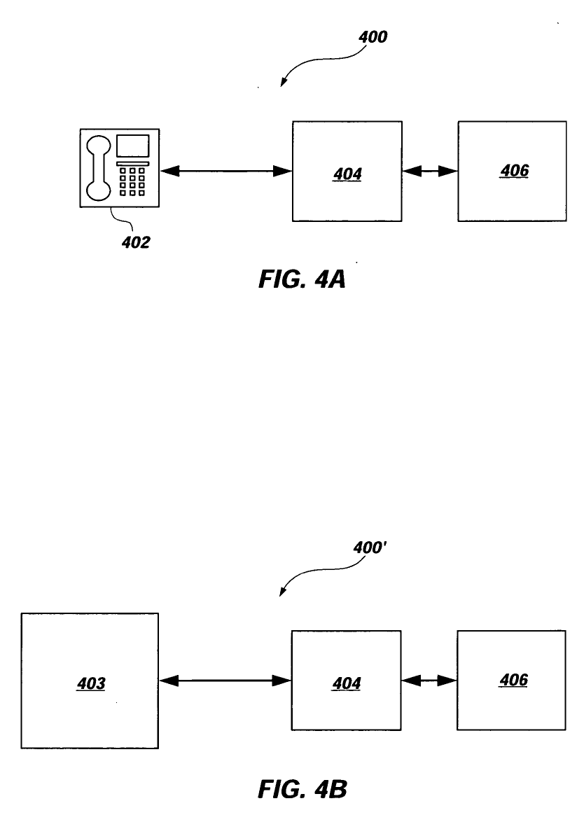

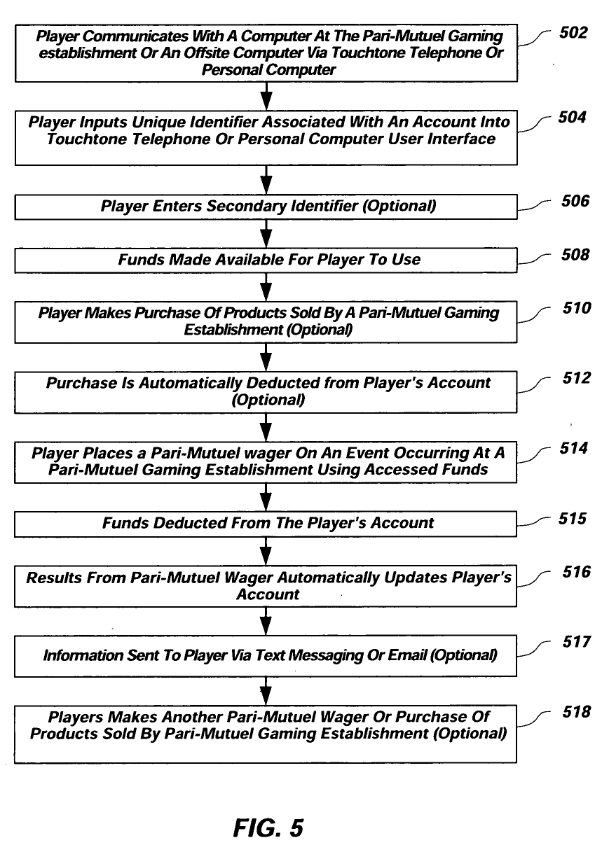

Referring to FIGS. 4A and 4B, a pari-mutuel gaming system 400 and 400′ are illustrated using block diagrams, in which the pari-mutuel gaming methods of the present invention described in process flow diagram of FIG. 5 may be implemented. As shown in FIG. 4A, the pari-mutuel gaming system 400 utilizes a touchtone telephone 402 for a player to place a pari-mutuel wager from a location off-site to the pari-mutuel gaming establishment such as, for example, a player's home or hotel room, etc. Again referring to FIG. 4A, a touch tone telephone 402 may be in communication with a remote computer 404. The remote computer 404 may be located at a pari-mutuel gaming establishment or may be located off-site from a pari-mutuel gaming establishment such as at an office building. The remote computer 404 may be configured to calculate odds, pool bets from multiple bets, and store the player's account information and balance. If the remote computer 404 does not contain the player's account information and balance, the remote computer may be in communication with a financial network 406 which may comprise a financial server 121 (FIG. 1C) or an EFT system 120 and card issuing system 122 (FIG. 1B) via phone line, cable line, or other suitable connection to enable access to the player's account information and balance as effected in the previous embodiments. The communication may be effected between touchtone telephone 402 and remote computer 404 via a conventional phone line.

As shown in FIG. 4B, if a personal computer 403 is used, the communication with the remote computer 404 may be effected using a phone line, cable line, Internet, or other suitable technology. The personal computer 402 may be a conventional personal computer including the associated software to enable communication with remote computer 404. Such communication between the personal computer 402 and the remote computer 404 may occur over the internet or a direct connection. Again, the remote computer 404 may be located at a pari-mutuel gaming establishment or may be located off-site from a pari-mutuel gaming establishment such as at an office building. Furthermore, when either a touchtone telephone 402 or a personal computer 403 are used, the communication with the remote computer 404 may be encrypted for additional security if necessary or desired. It is also contemplated that wireless communications may be employed, using suitable encryption technology.

Referring to FIG. 5, a process flow diagram for an exemplary method of the present invention is illustrated, which method enables using a monetary account associated with a house card, or a credit/debit card for placing a pari-mutuel wager remotely over a touch tone telephone or a personal computer. If a house card is used, the house card may be “upgraded” from a house card that may only be able to be used at the pari-mutuel gaming establishment to a house card that is capable of being used for placing wagers remotely by the player having the house card account information reconfigured by the pari-mutuel gaming establishment to enable such a use. In act 502, the player communicates with the remote computer 404 which is located at a pari-mutuel gaming establishment or at an offsite location. The communication may be initiated by the player dialing a phone number if a touchtone telephone 402 is used or by utilizing an internet connection if a personal computer 403 is used.

In act 504, the player inputs a unique identifier associated with an account such as a house card number or a credit/debit card number. The account may be associated with a house card or the account may be a credit/debit card account as described in the previous embodiments of FIGS. 2A, 2B and 3. The player may input the unique identifier by selecting the appropriate numbers corresponding to the account number on the keypad of the touchtone telephone 402. If a personal computer 403 is used, the player may input the account information in a user interface on the personal computer. The user interface may be made available to the player by accessing a specific host website. Optionally, for security purposes, in act 506 the player may enter a secondary identifier (e.g., a PIN or password) using either the keypad of the touchtone telephone 402 or the user interface of the host website. The account may be locked-out (i.e., access to the account prevented) if the player enters the incorrect PIN or password a predetermined number of times. In act 508, funds from the player's account are made available for the player to use.

Following the funds being made available to the player, in act 510, the player may optionally purchase products sold by the pari-mutuel gaming establishment via the telephone 402 or internet. Examples of products that may be purchased are handicapping information, souvenirs, clothing that carries the logo of the particular pari-mutuel gaming establishment, etc. The purchase may automatically be deducted from the player's account in act 512 as performed in the previous embodiments of FIGS. 2A, 2B, and 3. In act 514, the player may then place a pari-mutuel wager on an event occurring at a particular pari-mutuel gaming establishment using the accessed funds from the player's account. This may be accomplished by the player inputting the required information via touchtone telephone 402 or inputting the required information over a user interface on the internet if personal computer 403 is used. If a remote computer 404 is acting as a central server, the player may be required to select, using either the keypad of the touchtone telephone 402 or a user interface over the internet, at which pari-mutuel gaming establishment he or she desires to place a wager. For instance, the player may have the option of wagering at a number of different pari-mutuel gaming establishments (i.e., different horse or dog race tracks). The remote computer 404 may automatically deduct the funds wagered from the player's account in act 515. Following the results of the pari-mutuel wager, in act 516 the remote computer 404 automatically updates the player's account balance. Acts 515 and 516 may also be performed as in the previous embodiments of FIGS. 2A, 2B and 3. In other words, after the event that the player wagered upon is over, the player's account balance is updated such that winnings are added to the account balance. Following the results of the pari-mutuel wager, in act 517, which may occur after or simultaneously with act 516, the results may be sent to the player via text messaging to a player's pager, cellular phone, or emailed to the player's email address. If the player used a house card to make a purchase or place a wager, the account balance associated with the house card may also be sent to the player via text messaging to a player's pager, cellular phone, or emailed to the player's email address. Also, after placing his or her wager, the player may optionally continue to place wagers on different events or make purchases of products sold by the pari-mutuel gaming establishment in act 518. If the funds of the account associated with the house card are depleted or if the player desires additional funds, the player may add funds to the account using credit/debit card. The player may input his or her credit/debit card number to replenish the house card account or to add additional funds to it using the touchtone telephone 402 or a user interface at the host website.

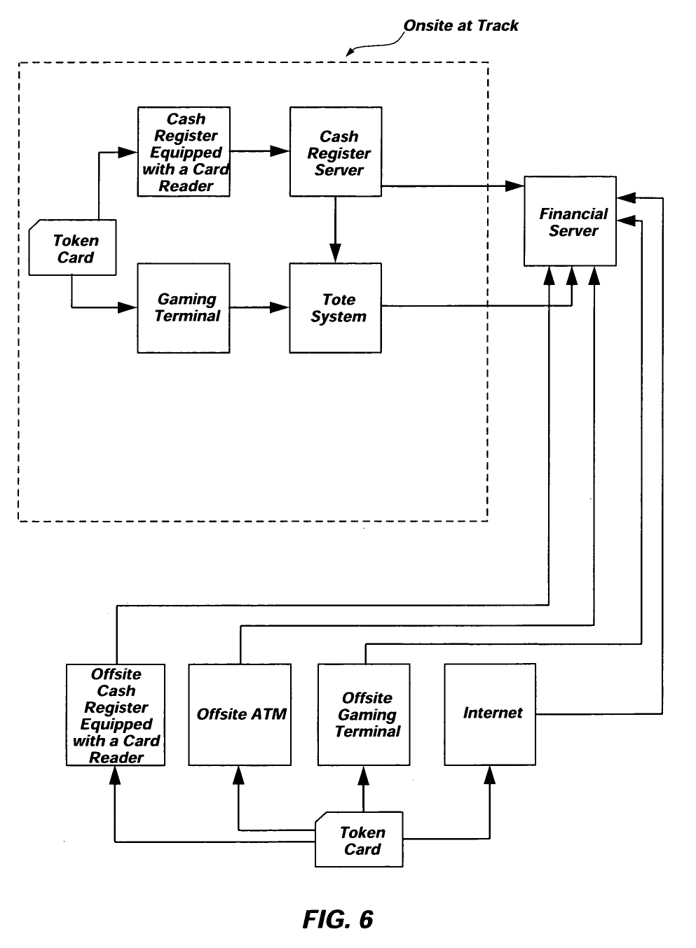

Many of the broad aspects of the present invention may be appreciated by referring to FIG. 6. As an example, a token card which may be a house card, smart card, debit card, credit card, etc may be used onsite at a pari-mutuel gaming establishment such as a horse track to access funds. The token card may be used at a gaming terminal or by way of example a cash register configured to read the token card. The player's account information and balance may be accessed from the tote system if the information is contained thereon or from an offsite financial server or similar device. The token card may also be used offsite at a cash register configured to read the token card, an offsite ATM, or an offsite gaming terminal. The account associated with the token card may also be used to place wagers and buy goods and/or services over the internet or phone.

Although the foregoing description of embodiments contains many specifics, these should not be construed as limiting the scope of the present invention, but merely as providing illustrations of some exemplary embodiments. Similarly, other embodiments of the invention may be devised which do not depart from the spirit or scope of the present invention. The scope of the invention is, therefore, indicated and limited only by the appended claims and their legal equivalents, rather than by the foregoing description. All additions, deletions, and modifications to the present invention, as disclosed herein, which fall within the meaning and scope of the claims are embraced thereby.

1. A cashless method of pari-mutuel wagering comprising: providing a gaming terminal at an establishment, the gaming terminal configured for a player to place a pari-mutuel wager on an event;
presenting a house card associated with a monetary account to a card reader in communication
with the gaming terminal;
accessing at least a portion of funds of the monetary account for use at the gaming terminal; placing a pari-mutuel wager at the gaming terminal on an event using the at least a portion of the funds; and
placing a purchase using the house card at the establishment using at least another portion of the funds.

2. The method according to claim 1, wherein placing the purchase using the house card is effected before placing the pari-mutuel wager.

3. The method according to claim 1, wherein placing the purchase using the house card is effected after placing the pari-mutuel wager.

4. The method according to claim 1, further comprising using the house card to access a secure area at the establishment.

5. The method according to claim 1, further comprising using the house card to access an informational display at the establishment.

6. The method according to claim 1, further comprising adding additional funds to the monetary account.

7. The method according to claim 1, wherein accessing the at least a portion of funds comprises sending a request for allocation of the at least a portion of funds to a remote computer in communication with the card reader.

8. The method according to claim 7, wherein accessing the at least a portion of funds further comprises receiving the at least a portion of funds requested from an authorization sent to the gaming terminal from the remote computer.

9. The method according to claim 1, further comprising updating the monetary account with winnings from a result of the pari-mutuel wager.

10. The method according to claim 1, further comprising selecting the house card from the group consisting of a smart card, a magnetic strip card, a radio frequency identification transmitter, and a card encoded with a bar code or other coded indicia.

11. The method according to claim 1, further comprising selecting the house card to have a predenominated amount of funds.

12. The method according to claim 1, further comprising removing the house card prior to placing the pari-mutuel wager.

13. The method according to claim 1, further comprising verifying the identity of the player prior to the player accessing the at least a portion of funds.

14. The method according to claim 12, further comprising using a personal identification number, a key, a smart card, an electronic button for entering a personal identification number in a user interface of the gaming terminal, a finger print imaging device, or a retinal scan to verify the identity of the player.

15. The method according to claim 1, wherein accessing at least a portion of funds of the monetary account for use at the gaming terminal further comprises requesting a specific amount of funds as determined by the player.

16. The method according to claim 1, further comprising selecting the event to be a sporting event.

17. The method according to claim 1, further comprising forwarding information regarding an outcome of the pari-mutuel wager over a communication link.

18. The method according to claim 17, wherein forwarding information comprises sending the information using text messaging.

19. The method according to claim 17, wherein forwarding information comprises sending the information using email.

20. The method according to claim 1, further comprising selecting the house card to be associated with a first monetary account and with a second monetary account associated with a debit card accounts or a credit card account, and using the at least a portion of the funds from the first monetary account to place the pari-mutuel wager.

21. The method according to claim 20, further comprising crediting the first monetary account when a purchase is placed using funds from the second monetary account.

22. The method according to claim 21, further comprising selecting the funds from the first monetary account to be only available for use at the establishment.

23. The method according to claim 20, further comprising transferring funds between the first monetary account and the second monetary account.

24. A cashless method of pari-mutuel wagering comprising: providing a gaming terminal at an establishment, the gaming terminal configured for a player to place a pari-mutuel wager on an event;
presenting a credit card or a debit card associated with a monetary account to a card reader in communication with the gaming terminal;
accessing at least a portion of funds of the monetary account for use at the gaming terminal;
placing a pari-mutuel wager at the gaming terminal on an event using the at least a portion of the funds; and
placing a purchase using the credit card or the debit card at the establishment using at least another portion of the funds.

25. The method according to claim 24, wherein placing the purchase using the credit card or the debit card is effected before placing the pari-mutuel wager.

26. The method according to claim 24, wherein placing the purchase using the credit card or the debit card is effected after placing the pari-mutuel wager.

27. The method according to claim 24, further comprising selecting the gaming terminal to include the card reader.

28. The method according to claim 24, further comprising updating the monetary account with winnings from a result of the pari-mutuel wager.

29. The method according to claim 24, further comprising removing the credit card or the debit card prior to placing the pari-mutuel wager.

30. The method according to claim 24, further comprising verifying the identity of the player prior to the player accessing the at least a portion of funds.

31. The method according to claim 30, further comprising using a personal identification number, a key, a smart card, an electronic button for entering a personal identification number in a user interface of the gaming terminal, a finger print imaging device, or a retinal scan to verify the identity of the player.

32. The method according to claim 24, wherein accessing the at least a portion of funds comprises sending a request for an allocation of the at least a portion of funds to a remote computer in communication with the card reader.

33. The method according to claim 32, wherein accessing the at least a portion of funds further comprises the remote computer forwarding the request to an electronic funds transfer system.

34. The method according to claim 33, wherein accessing the at least a portion of funds further comprises the electronic funds transfer system forwarding the request to a credit issuing system.

35. The method according to claim 32, wherein accessing the at least a portion of funds further comprises receiving the at least a portion of funds requested from an authorization sent to the gaming terminal from the remote computer.

36. The method according to claim 24, further comprising selecting the event to be a sporting event.

37. The method according to claim 24, further comprising forwarding information regarding an outcome of the pari-mutuel wager over a communication link.

38. The method according to claim 37, wherein forwarding information comprises sending the information using text messaging.

39. The method according to claim 37, wherein forwarding information comprises sending the information using email.

40. A cashless method of pari-mutuel wagering comprising: inputting a unique identifier associated with a monetary account over a communication link with a remote computer;
accessing at least a portion of funds from the monetary account;
placing a pari-mutuel wager over the communication link on an event using the at least a portion of the funds; and
placing a purchase of goods or services sold at an establishment over the communication link using another portion of the funds.

41. The method according to claim 40, wherein inputting the unique identifier comprises inputting an account number using a touch tone telephone.

42. The method according to claim 41, further comprising inputting a unique secondary identifier number using the touchtone telephone.

43. The method according to claim 40, wherein placing the pari-mutuel wager over the communication link comprises inputting the pari-mutuel wager using a touch tone telephone.

44. The method according to claim 40, wherein placing the pari-mutuel wager over the communication link comprises inputting a code corresponding to a specific pari-mutuel gaming establishment.

45. The method according to claim 40, wherein inputting the unique identifier comprises inputting an account number into a user interface of a website that communicates with the remote computer.

46. The method according to claim 45, further comprising inputting a unique secondary identifier into the user interface of the website that communicates with the remote computer.

47. The method according to claim 45, further comprising placing a purchase of at least one item sold by the establishment.

48. The method according to claim 40, further comprising selecting the monetary account to be associated with a house card.

49. The method according to claim 48, further comprising adding funds to the monetary account associated with the house card.

50. The method according to claim 48, further comprising selecting the house card to have a predenominated amount of funds.

51. The method according to claim 40, further comprising selecting the monetary account to be associated with a debit or credit card.

52. The method according to claim 40, further comprising updating the monetary account with winnings from a result of the pari-mutuel wager.

53. The method according to claim 40, further comprising verifying the identity of the player prior to the player accessing the at least a portion of funds.

54. The method according to claim 48, further comprising selecting the house card from the group consisting of a smart card, a magnetic strip card, a radio frequency identification transmitter, and a card encoded with a bar code or other coded indicia.

55. The method according to claim 48, further comprising selecting the house card to be associated with a first monetary account and a second monetary account associated with a debit card accounts or a credit card account and using at least a portion of the funds from the first monetary account to place the pari-mutuel wager.

56. The method according to claim 55, further comprising crediting the first monetary account when a purchase is placed using funds from the second monetary account.

57. The method according to claim 56, further comprising selecting the at least a portion of funds from the first monetary account to be only available for use at the establishment.

58. The method according to claim 55, further comprising transferring funds between the first monetary account and the second monetary account.
